(19) United States
(12) Patent Application Publication
(10) Pub. No.: US 2009/0089331 A1
(43) Pub. Date: Apr. 2, 2009

(54) Real-Time Method and System for Tracking Mail

(76) Inventors: Thomas L. Boaz, Round Rock, TX (US); Micah J. Roark, Waco, TX (US); Richard B. Rogers, Leander, TX (US); David R. Anderton, Lorena, TX (US)

Correspondence Address: AARON M. WILKERSON, P.O. BOX 588, CHINA SPRING, TX, 76633, US

(21) Appl. No.: 12/059,680

(22) Filed: Mar. 31, 2008

Related U.S. Application Data
(60) Provisional application No. 60/910,070, filed on Apr. 4, 2007.

(51) Int. Cl. G06F 17/30; H04L 9/32

(52) U.S. Cl. 707/104.1; 726/7; 707/E17.045

(57) ABSTRACT

The present invention provides a real-time, instantaneous method and system for tracking mail. The system utilizes an intelligent, hand-held, portable data entry and data processing device to collect information regarding a mailpiece delivered to a mail distribution facility. The device is linked via the internet to a globally accessible relational database that permanently stores and efficiently and continuously tracks the mailpiece from receipt of the mailpiece in the mail distribution facility until delivery to its final destination. The system effectively utilizes signature capture and location codes to track the mailpiece at all times until final delivery.

### CROSS-REFERENCE TO RELATED APPLICATIONS

The present application claims the benefit of Provisional Application Number 60/910,070 filed Apr. 4, 2007, which is incorporated herein by reference.

### BACKGROUND OF THE INVENTION

1. Field of the Invention

The present inventive subject matter relates to mail tracking, and more particularly relates to methods for real-time mail tracking utilizing intelligent, hand-held, portable data entry and data processing devices, unique identifier barcodes and a globally accessible relational database accessed via the internet.

2. Background Information

For many years, parcel delivery services such as United Parcel Service or the United States Postal Service have maintained various types of records to verify parcel deliveries. These “parcels” may include pieces of mail, packages, letters, mailpieces, and may be referred to herein as “parcel(s), package(s) or mailpiece(s).” Over the last few years, parcel delivery services have begun capturing parcel tracking information (or data) with portable electronic devices such as the Delivery Information Acquisition Device utilized by the United Parcel Service. While parcel tracking technology has steadily developed, the parcel delivery industry still suffers from certain parcel tracking deficiencies.

One particular deficiency is a slow delivery of information. For example, data is typically captured (if at all) by hand-held devices that run in “batch” mode. The data is collected into the device, and the device is later connected to a computer to synchronize the data, or push the updates/changes into the application. The later synchronization results in data such as package location, delivery status, availability, etc, being temporarily inaccurate in the system because of the time lag between the collection of the data and the synchronization.

Another deficiency in the industry is the ability of “workstation-based” systems to scale. Some data tracking systems, including the batching/syncing system described above, utilize one computer for all of the information tracking. The resultant drawbacks are a slowdown in data entry time, a slowdown on data access, a limitation on the number of people that can interact with the system at one time, a need for the traditionally unreliable periodic workstation backup, certain software/hardware requirements from the application vendor that may be difficult to match or continually update to stay secure, and increased cost and overhead involved with the installation, maintenance and updating of the workstation software in order to use the system. Even though some systems offer multiple workstation linking to enable more people to interact at once, but the other resultant drawbacks still apply.

Yet another deficiency in the industry is that existing systems utilize inflexible, uneditable binary executable format, software applications. These software applications are typically prepackaged and are not easily or cost-effectively adjustable to the needs of the end user.

Additionally, many existing systems lack a single “user login”, with the application open to all individuals with either no tracking ability, or simply one user logged in for all users. The lack of a single “user login” reduces the integrity of the data by failing to accurately capture the identity of the user that made the data entry or transaction. This is particularly true of the mobile devices used for capture.

Existing parcel tracking systems do not allow the ability to track a package's location within a mail facility. Although traditionally packages might be accounted for at “transactions” such as receipt and delivery, the positions of those packages are not specifically tracked within the mail facility, which creates opportunities for package loss or package mis-deliveries within the mail facility.

Existing parcel tracking systems also suffer from the inability to track typical “unmarked” (untrackable) pieces. In the industry, packages without a barcode or article number are traditionally not tracked. These unmarked packages are often lost with regular untrackable mail, or delivery is slowed tremendously.

Finally, another deficiency in the existing parcel tracking industry is an inability to produce an audit trail on a package's transactions. Most paper logs, and even electronic tracking systems do not track each individual transaction as a package moves from, for example, a delivery carrier to a mail center to a storage location to delivery of the package, and in some cases transfers of the package between mail centers. Consequently, when a package is missing, misdelivered, or damaged, it is virtually impossible to determine with certainty the location of the package or determine the precise location where the mistake or damage may have occurred.

In view of the limitations of products, systems and methods currently known in the art, there is a need for a real-time, efficient method and system for tracking mail. The present invention, by its novel design provides a solution in view of currently available devices and methods.

### SUMMARY OF THE INVENTION

In view of the foregoing, it is an object of the present invention to provide a “real-time” parcel information capture where once the information is captured, the information is immediately transmitted and updated in the application.

It is another object of the present invention to provide a system that utilizes the internet for interaction, and all parcel tracking information is stored on a globally accessible, central, redundant server. This allows for scaling the number of access points from one-to-many, which instantaneously speeds up data entry and access time and increases the number of users accessing the system at one time. A globally accessible, central, redundant server allows for offsite automatic system backups, which meets backup/disaster recover/business continuity requirements.

It is another object of the present invention to provide a system that utilizes simple hardware and software requirements. The hardware and software requirements of the present invention are fundamentally simple, which entail a web browser and an Internet connection with web access (preferably port 80).

It is another object of the present invention to provide a system that is efficient and easy to maintain.

It is another object of the present invention to provide a system that allows flexibility in the installation and maintenance of the system.

It is another object of the present invention to provide a system that tracks and links user identity with entered information.

It is yet another object of the present invention to provide a system that instantly tracks and determines the location of a package.

It is another object of the present invention to provide a system that provides identification means for unmarked packages.

It is yet another object of the present invention to provide a system that records and permanently stores all entered information.

In satisfaction of these and other related objectives, the present invention provides such a method and system for tracking mail.

The present invention provides for real-time tracking of a marked or unmarked mailpiece following the delivery of a mailpiece to a mail distribution facility. Following receipt of the mailpiece, a mail technician operates an intelligent, hand-held, portable data entry and data processing device and logs into a mail tracking application. The mail tracking application links via the internet to a globally accessible relational database. The mail technician scans and enters mailpiece tracking information into the device, where, once linked, the relational database collects and permanently stores the tracking information, providing real-time, instantaneous, continuous, accurate tracking of the mailpiece for a variety of users.

### BRIEF DESCRIPTION OF THE DRAWINGS

These and other features, aspects, and advantages of the present invention will become better understood with regard to the following description, appended claims, and accompanying drawings where:

FIG. 1 is a diagram of the overall system of the present invention;

FIG. 2 is an illustration depicting the sequence of steps for processing and tracking a mailpiece shown within the diagram in FIG. 1.

FIG. 3A is a front plan view of an intelligent, hand-held, portable data entry and data processing device utilized within the system shown in FIG. 1;

FIG. 3B is a block diagram of steps for accessing the mail tracking database;

FIG. 4A is an illustration depicting the sequence of steps for the mail tracking application to wirelessly connect to the mail tracking database shown within the diagram in FIG. 3B.

FIG. 4B is an illustration depicting the sequence of steps for the mail tracking application to connect by cable to the mail tracking database shown within the diagram in FIG. 3B.

FIG. 5A is a block diagram with accompanying illustration depicting the steps for processing a marked mailpiece.

FIG. 5B is a block diagram with accompanying illustration depicting the steps for processing an unmarked mailpiece.

FIG. 6 is a block diagram with accompanying illustration depicting the steps for a mail technician to enter additional information into the mail tracking database.

FIG. 7 is a block diagram with accompanying illustration depicting the steps for creating and affixing a unique barcode to a mailpiece.

FIG. 8A is a block diagram with accompanying illustration depicting the steps for a mail technician to distribute a trackable mailpiece to a recipient or locator code.

FIG. 8B is a block diagram depicting the steps for distributing a trackable mailpiece.

### DESCRIPTION

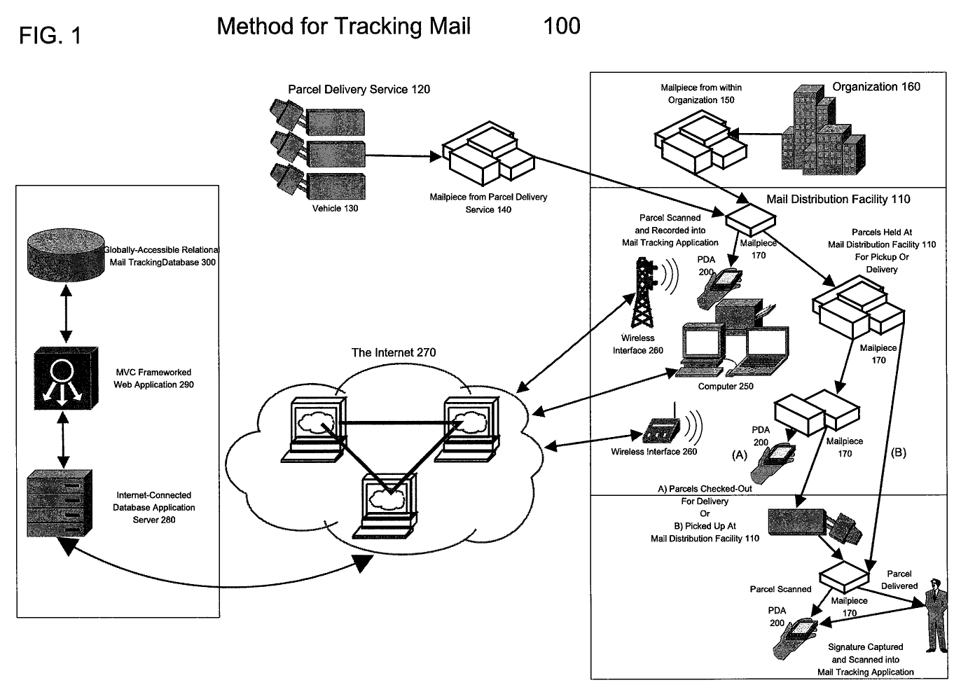

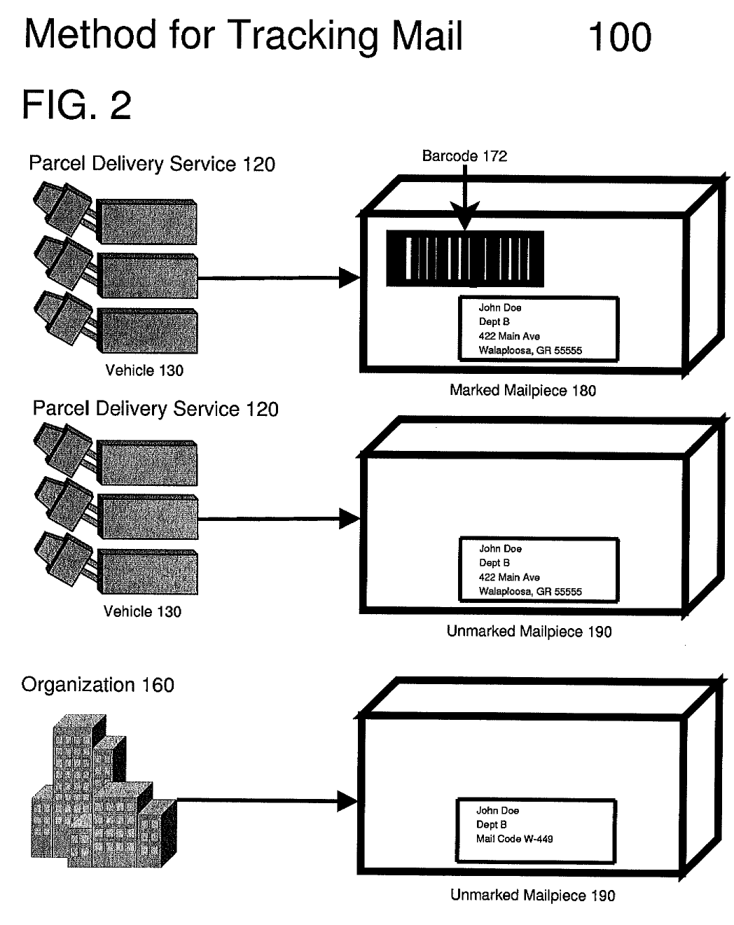

FIG. 1 illustrates the sequence of steps executed in order for one or more items received from a mail delivery service or a parcel delivery service or an organization to be instantaneously tracked in real-time until delivery of those items. FIG. 1 shows an overview of a method for tracking mail 100 embodying the present invention in flowchart form, while FIGS. 2-8B show more details regarding the sequence of steps involved.

In order to implement this sequence of steps, a piece of mail, a package, a parcel, or a mailpiece, hereinafter collectively referred to as a “mailpiece”, is delivered to a mail distribution facility 110. This can occur when an employee of a parcel delivery service 120, as shown on FIG. 1, delivers a mailpiece 140 to a mail distribution facility 110. Additionally, from time to time, the delivery of a mailpiece 150 is necessary internally within an organization 160 when the mailpiece 150 never enters the “mail stream”, and thus makes the mailpiece 150 difficult to track within the organization. Employees within the organization 160 can also deliver the mailpiece 150 to the mail distribution facility 110. FIG. 1 shows the delivery of the mailpiece 140 from the parcel delivery service 120 and the delivery of the mailpiece 150 from the organization 160.

As shown on FIG. 1, whether received from the parcel delivery service 120 or the organization 160, a mailpiece 170 comprises one item received into the mail distribution facility 110. The mailpiece 170 will typically arrive bearing some information, including the intended recipient's name, the intended recipient's location, postage delivery charges and other information. As shown on FIG. 2, in some instances, a mailpiece will bear a barcode 172 containing information for the processing and tracking of the mailpiece, such mailpiece hereinafter referred to as a “marked” mailpiece 180. “Marked” mailpieces can include registered, express, certified or overnight items using barcodes from parcel delivery carriers such as Fedex, UPS, United States Postal Service, and DHL. In other instances, a mailpiece will arrive unmarked with any barcode identifier, hereinafter referred to as an “unmarked” mailpiece 190, which can sometimes occur with first class mail, priority mail or mail items delivered within an organization.

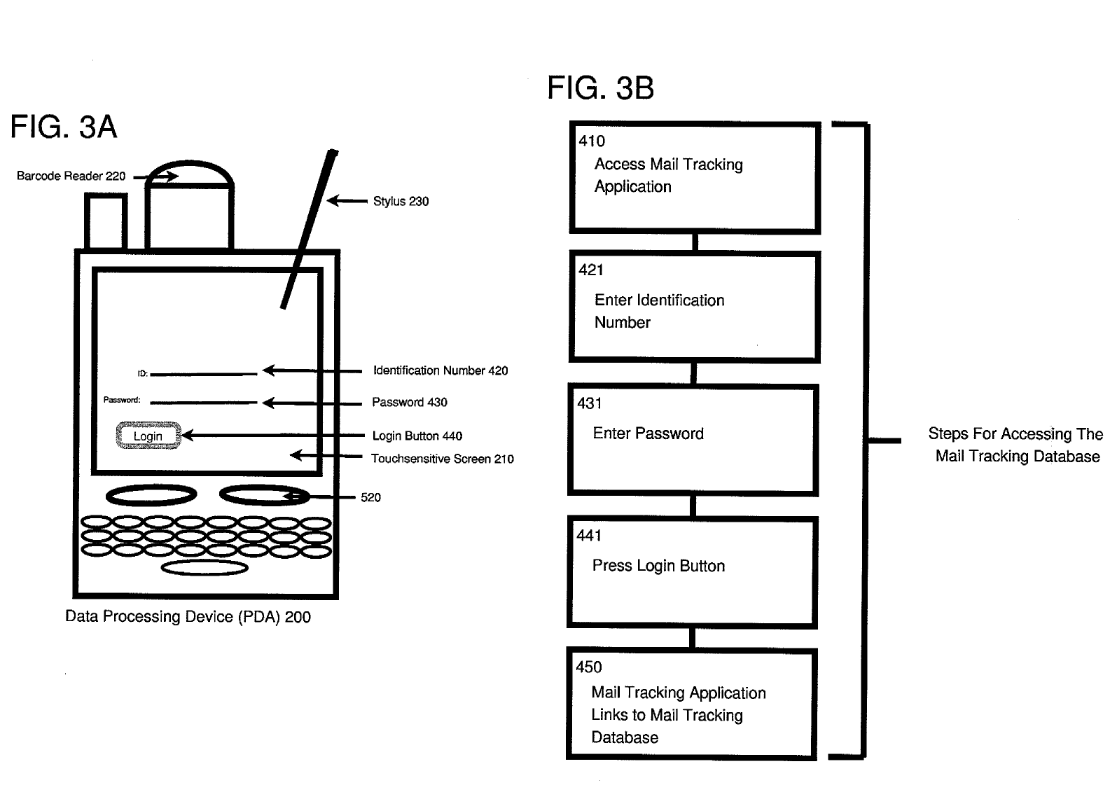

An employee at the mail distribution facility 110, hereinafter referred to as the “mail technician,” operates an intelligent, hand-held, portable data entry and data processing device 200 of the type known as a personal digital assistant (PDA), as shown in FIG. 3A. The PDA 200 includes a touchsensitive data entry and a display screen 210 capable of capturing handwriting, hereinafter referred to as a “PDA screen”, a means for scanning and reading barcodes 220, hereinafter referred to as a “barcode reader”, a stylus 230 for inputing data onto the touchsensitive screen 210, and a pre-installed web-based mail tracking software application, the application which is hereinafter referred to as the “mail tracking application”.

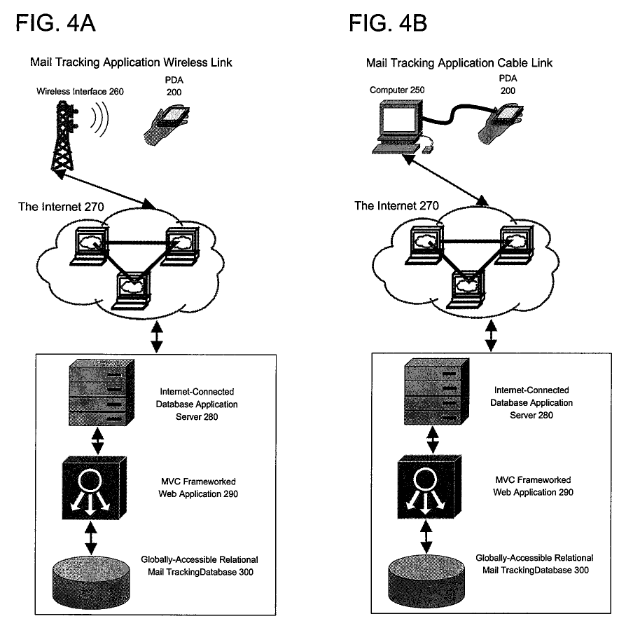

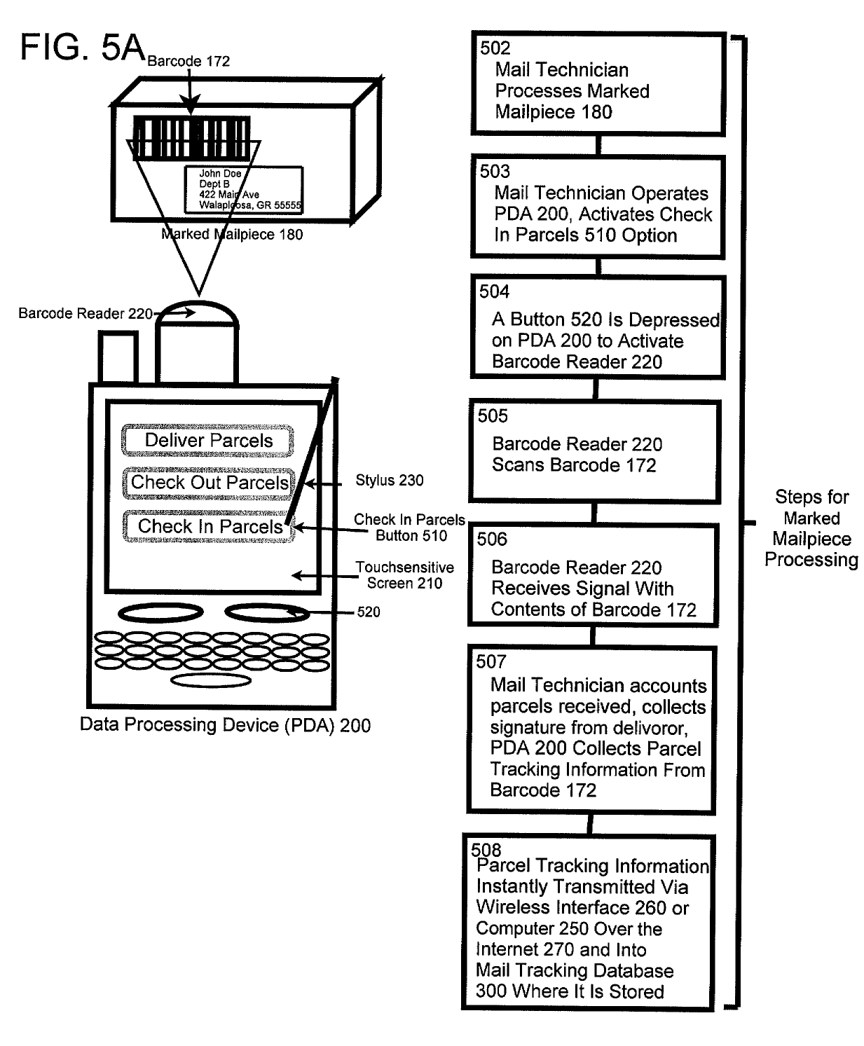

Referring to FIG. 3B, in steps for accessing a mail tracking database, the mail technician accesses a globally accessible relational database 300, hereinafter referred to as the “mail tracking database”, in a first step 410, by first manually logging into the mail tracking application included on the PDA 200. In a second step 421, the mail technician logs into the mail tracking application by inputting an identification number 420 and, in a third step 431, a password 430 into the PDA 200 and, in a fourth step 441, pressing the “Login” button 440 on the PDA screen 210. In a fifth step 450, the mail tracking application links to the mail tracking database 300 by utilizing those steps outlined below and shown in FIGS. 4A and 4B. A correct entry of login information enables the mail technician constant access to the mail tracking database 300 until such time that the mail technician logs out of the mail tracking application or the connection is disrupted. It is important to note that to maintain the integrity of the system, any information entered into the mail tracking database 300 cannot be altered, changed, or deleted.

Prior to and in preparation for receiving the “marked” mailpiece 180 or the “unmarked” mailpiece 190, the mail technician activates the mail tracking application on the PDA 200 as set forth above and links to the mail tracking database 300 as set forth herein. The PDA 200 may be wireless or connected by a cable or other known means to a computer 250. As shown in FIG. 4A, the mail tracking application Tirelessly links through a wireless interface 260, which transmits a signal, through the internet 270 to an internet connected application/database server 280, through an MVC frameworked web application 290 and into the mail tracking database 300. If the PDA 200 is connected by a cable or other known means to the computer 250 as shown in FIG. 4B, the mail tracking application bypasses the wireless interface 260 and is linked to the internet 270. The mail tracking application is then linked through the internet connected application/database server 280 to an MVC frameworked web application 290 and subsequently to the mail tracking database. The mail tracking database 300 collects, stores and disseminates tracking information regarding the “marked” mailpiece 180 or the “unmarked” mailpiece 190. Those skilled in the art will understand that the data flow to the mail tracking database 300 is accomplished through a user's access of the internet 270, which data flow is then linked through the internet connected application/database server 280 to the MVC frameworked web application 290 and then into the mail tracking database 300. Those skilled in the art will also understand that the data flow from the mail tracking database 300 is accomplished in the reverse order of that described for data flow to the mail tracking database 300.

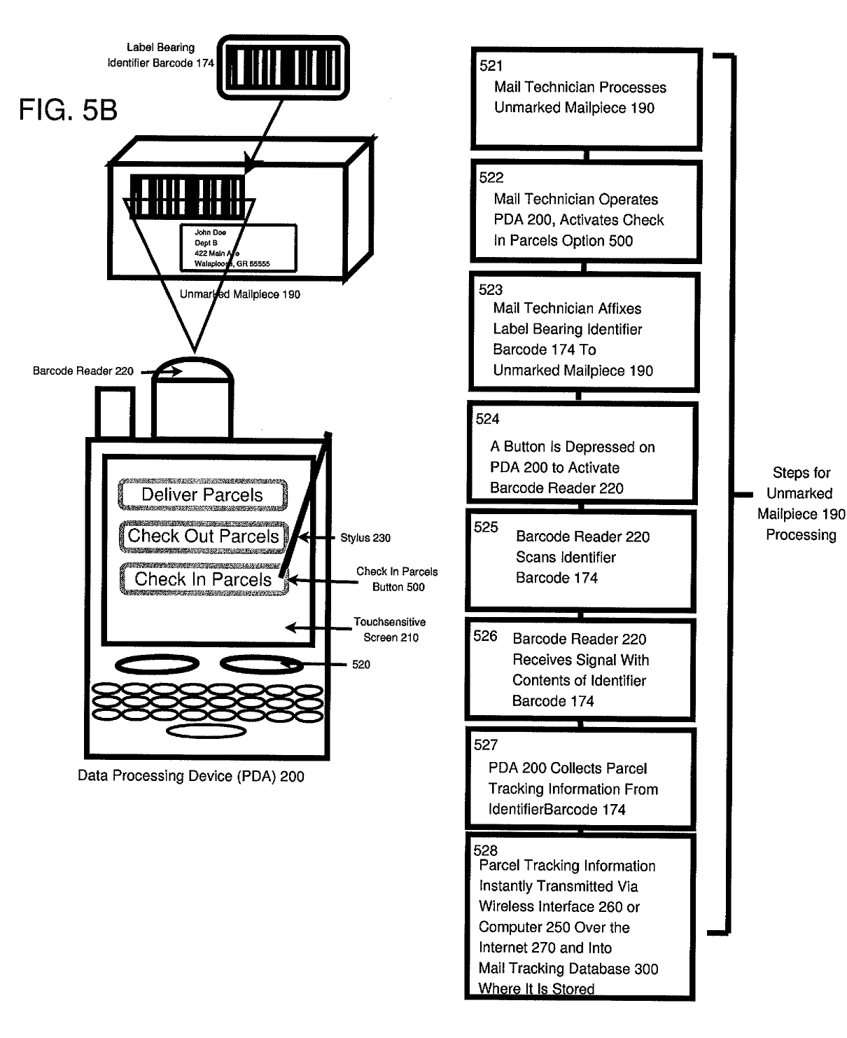

FIG. 5A illustrates a series of steps commencing when, in a first step 502, the mail technician receives a “marked” mailpiece 180. In a second step 503, the mail technician operates the PDA 200 to check in the items by activating an operator menu option on the PDA 200 to “Check In Parcels” 510. In a third step 504, a button 520 is depressed on the PDA 200 to activate the barcode reader 220 of the PDA 200. In a fourth step 505, the barcode reader 220 scans the barcode 172 and, in a fifth step 506, receives a signal containing the contents of the barcode 172. In a sixth step 507, the mail technician accounts for the mailpieces received (the “accounting information”), the deliverer's signature is collected (the “signature”) and the PDA 200 collects the parcel tracking information collected from the barcode, as well as the accounting information and the signature, which, in a seventh step 508, are all instantaneously transmitted via the wireless interface 260 or the computer 250, over the internet 270 and into the mail tracking database 300, where it is stored.

FIG. 5B illustrates a series of steps commencing when, in a first step 521, the mail technician receives an “unmarked” mailpiece 190. In a second step 522, the mail technician operates the PDA 200 to check in the items by activating an operator menu option on the PDA 200 to “Check In Parcels” 510. In a third step 523, the mail technician affixes a label bearing an identifier barcode 174 to the “unmarked” mailpiece 190. In a fourth step 524, the mail technician depresses the button 520 on the PDA 200 to activate the barcode reader 220 of the PDA 200. In a fifth step 525, the barcode reader 220 scans the identifier barcode 174 and in a sixth step 526, receives a signal containing the contents of the identifier barcode 174. In a seventh step 527, the PDA 200 collects the parcel tracking information collected from the barcode, which, in an eighth step 528, is instantaneously transmitted via the wireless interface 260 or the computer 250, over the internet 270 and into the mail tracking database 300, where it is stored.

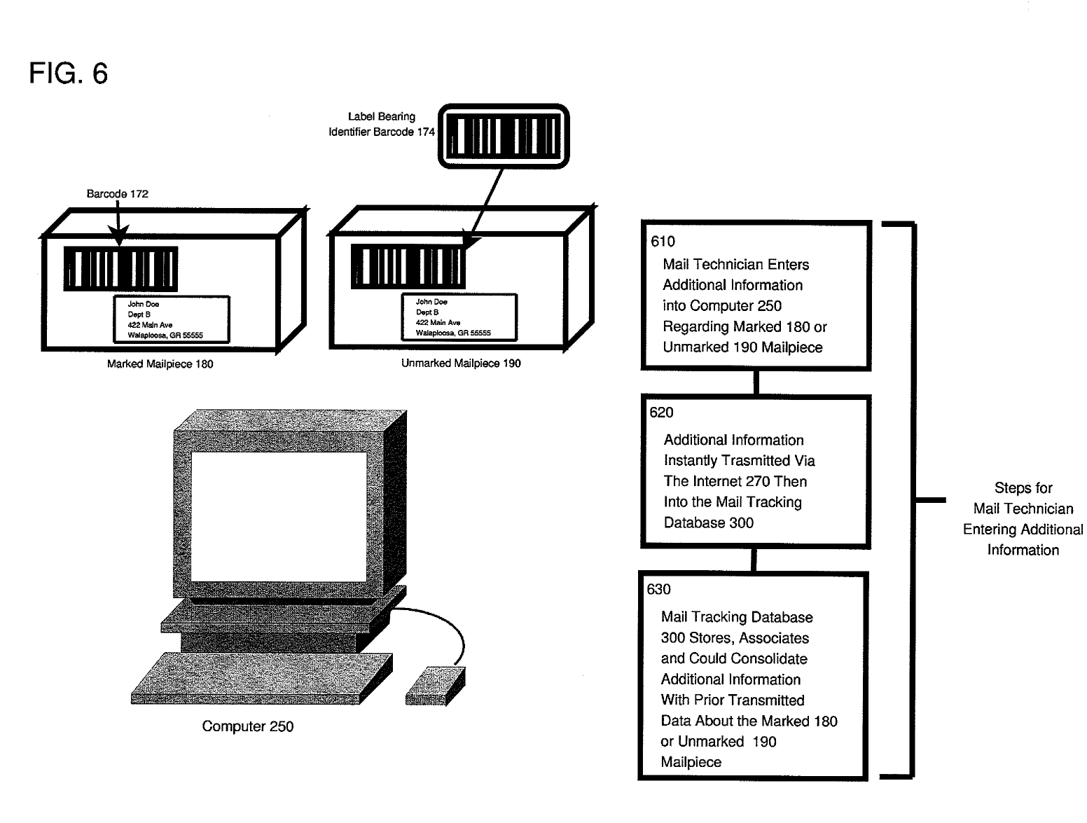

FIG. 6 shows the next steps in the method for tracking mail 100, which apply to a “marked” mailpiece 180 or an “unmarked” mailpiece 190. After transmitting the information for the “marked” mailpiece 180 or the “unmarked” mailpiece 190, as illustrated in FIGS. 5A and 5B, in a first step 610, the mail technician utilizes the computer 250 located at the mail distribution facility 110 that is additionally linked to the internet 270 and to the mail tracking database 300 to enter additional information regarding the “marked” mailpiece 180 or the “unmarked” mailpiece 190. The additional information may include the identity of the parcel delivery service, the type of mailpiece received, the date of receipt, the time of receipt, the identity of the sender, the identity of the recipient, any relevant internal organizational department information, the email address of the sender and the email address of the recipient. Following the manual entry of the additional information relating to the “marked” mailpiece 180 or the “unmarked” mailpiece 190, in a second step 620, the additional information is instantly transmitted via the internet 270 and then into the mail tracking database 300, where, in a third step 630, it is stored, associated and could be consolidated with the prior transmitted data related to the “marked” mailpiece 180 or the “unmarked” mailpiece 190, if such prior transmitted data had been sent.

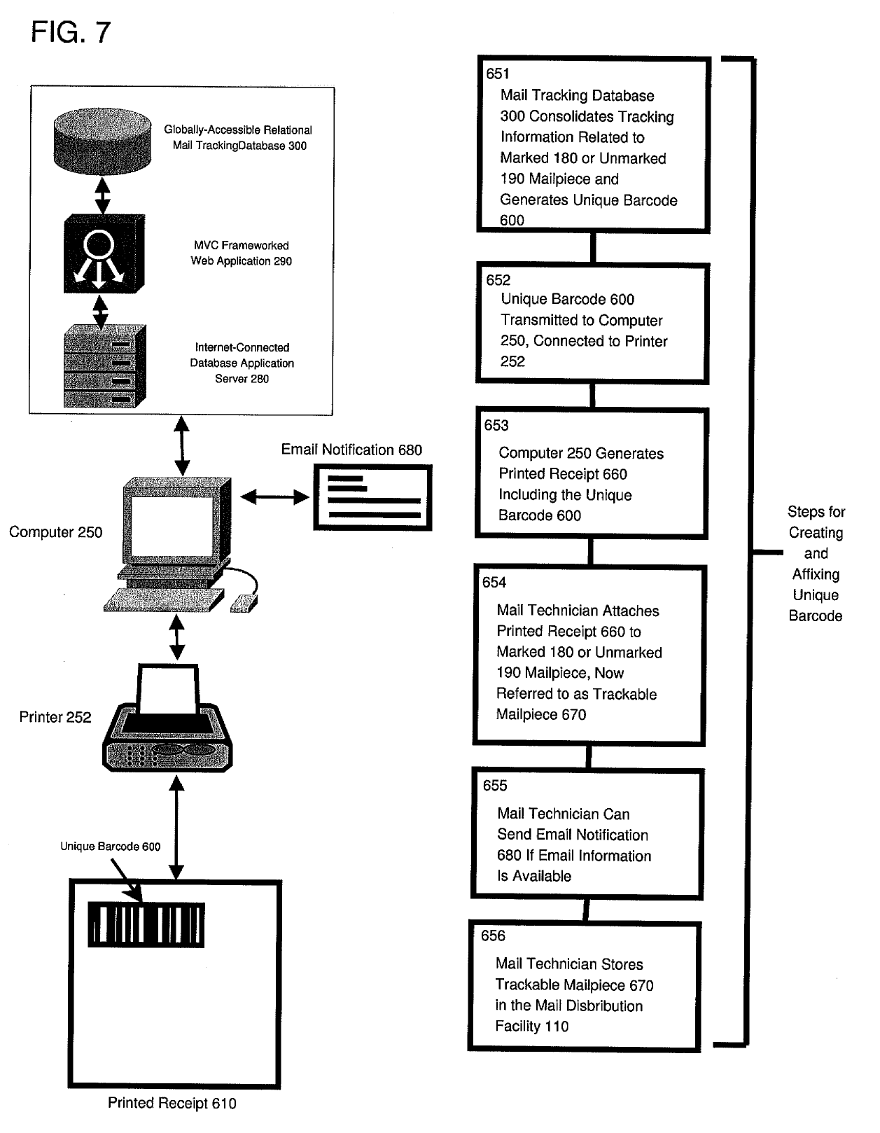

As shown on FIG. 7, in a first step 651, the mail tracking database 300 consolidates the tracking information related to the “marked” mailpiece 180 or the “unmarked” mailpiece 190 and generates a unique barcode 600, which is preferably a 3 of 9 barcode or a 2D data matrix barcode, enabling continued tracking of the mailpiece. The unique barcode 600 allows for the tracking of additional information regarding the “marked” mailpiece 180 or the “unmarked” mailpiece 190. In a second step 652, the unique barcode 600 is transmitted from the mail tracking database 300 back to the computer 250, which is connected to a printer 252. In a third step 653, the computer 250 generates a printed receipt 660 including the unique barcode 600. In a fourth step 654, the mail technician attaches the printed receipt 660 to the “marked” mailpiece 180 or the “unmarked” mailpiece 190, which allows for continued tracking of the “marked” mailpiece 180 or tracking of the previously untrackable “unmarked” mailpiece 190. The “marked” mailpiece 180 or the “unmarked” mailpiece 190 now become constantly trackable with the affixed unique barcode 600 and will be referred to hereafter as a “trackable mailpiece” 670. In a fifth step 655, when the printed receipt 660 is generated and if the email information is available, an email notification 680 can be instantly sent to the recipient and the sender. A printed receipt 660 may also be generated to notify the recipient of the arrival of the trackable mailpiece 670, and the receipt 610 can be placed within recipient's physical mailbox. The mail technician then scans a pre-marked location identifying code (the “location code”) located on a bar code in a pre-determined location in the mail distribution facility 110 with the PDA 200 and the trackable mailpiece 670 is stored at the pre-determined location in the mail distribution facility 110. The location code information can be tracked by the mail tracking database 300 by the steps as set forth in FIG. 7.

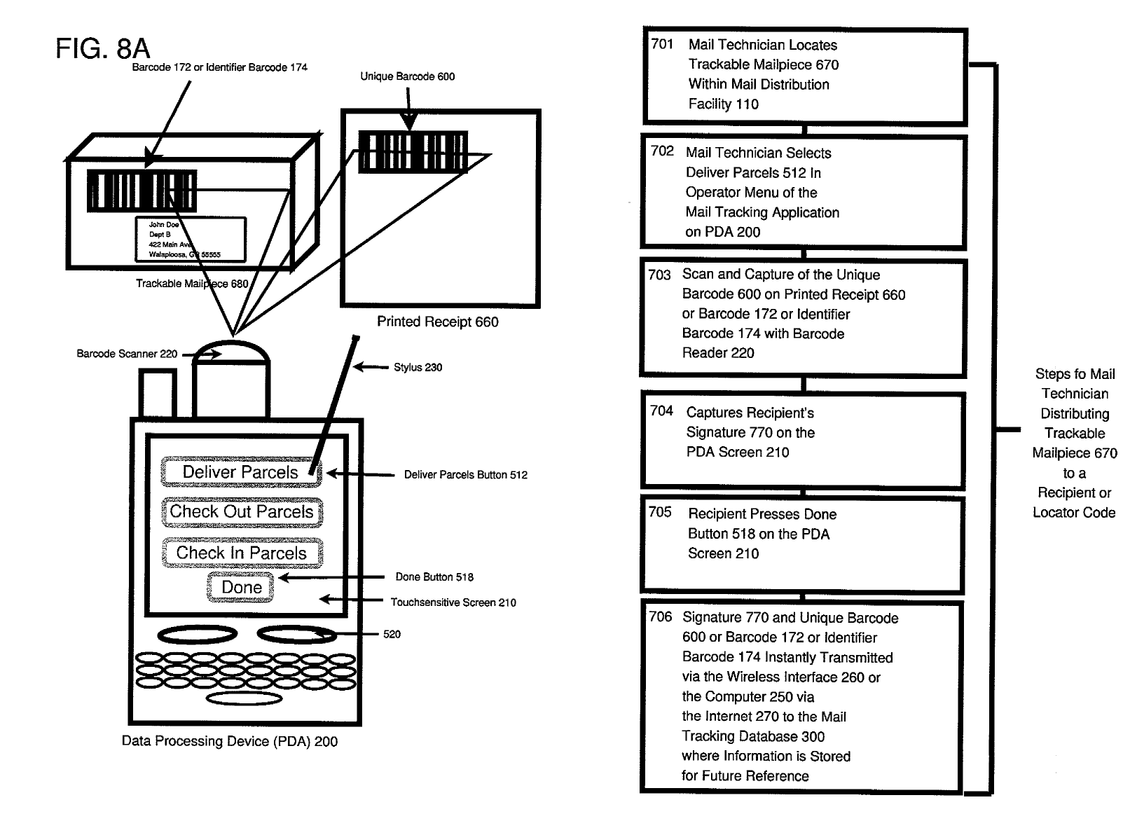

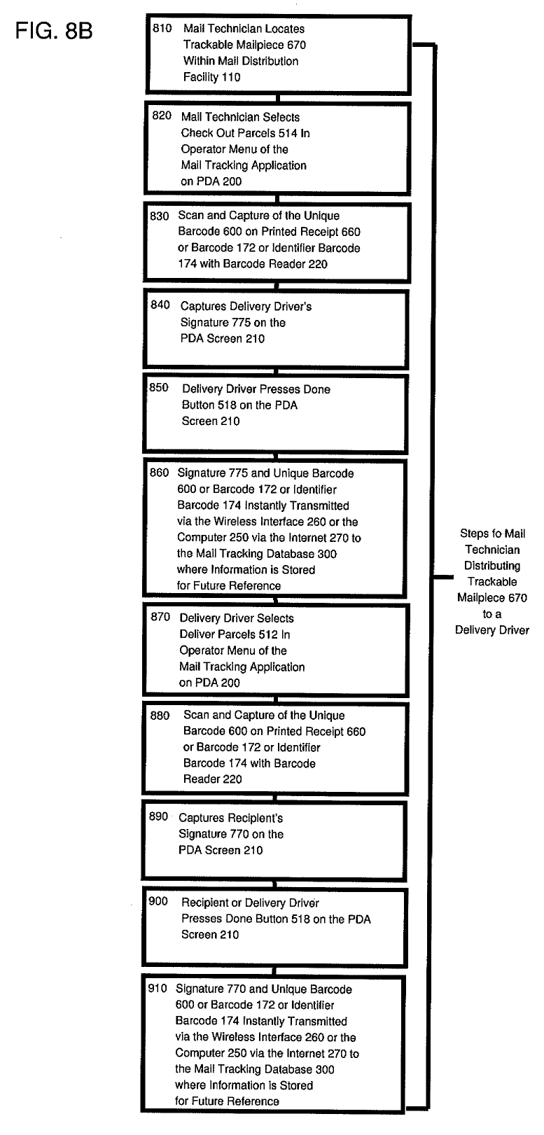

FIG. 8 shows distribution of the trackable mailpiece 670 from the mail distribution facility 110. Distribution can occur by (1) the mail technician physically delivering the trackable mailpiece 670 to the intended recipient of the trackable mailpiece 670, (2) the mail technician physically delivering the trackable mailpiece 670 to a specific location code or (3) by a delivery driver distributing the trackable mailpiece 670 to a recipient of the trackable mailpiece 670.

As shown on FIG. 8, in the first step 701, if the mail technician is physically distributing the trackable mailpiece 670 to the recipient of the trackable mailpiece 670, the mail technician locates the trackable mailpiece 620 within the mail distribution facility 110, in a second step 702, selects “Deliver Parcels” 512 in the operator menu 500 of the mail tracking application on the PDA 200, in a third step 703, scans and captures the unique barcode 600 located on the printed receipt 610 attached to the trackable mailpiece 620 or scans and captures the barcode 172 or scans and captures the identifier barcode 174 with the barcode reader 220 of the PDA 200, and in a fourth step 704, captures the recipient's signature 770 on the PDA screen 210. In a fifth step 705, the recipient presses the “Done” button 518 on the signature screen 210. At the recipient's press of the “Done” button 518, in a sixth step 706, the signature 770 and the unique barcode 600 or the barcode 172 or the identifier barcode 174 containing the tracking information are instantly transmitted via the wireless interface 260 or the computer 250, via the internet 270, and subsequently into the mail tracking database 300, where the information is stored for future reference. It is important to note that at any time after the initial information is transmitted into the mail tracking database 300, interested persons may instantly access the mail tracking database 300 using any computer via the internet 270 to determine parcel tracking information by inputting a specific web address and a password.

If the mail technician physically delivers the trackable mailpiece 670 to a specific location code, the mail technician, as opposed to the recipient, would sign on the PDA screen 210 when the trackable mailpiece 670 is delivered to the specific location code. Other related steps would be the same as described when the mail technician physically delivers the mailpiece to the recipient and are incorporated herein.

As shown in FIG. 8B, in a first step 810, if the mail technician distributes the trackable mailpiece 670 to a delivery driver 700, the mail technician locates the trackable mailpiece 670 within the mail distribution facility 110, in a second step 820, selects “Check-Out Parcels” 514 in the operator menu of the mail tracking application on the PDA 200, in a third step 830, scans and captures the unique barcode 600 located on the printed receipt 660 or scans and captures the barcode 172 or scans and captures the identifier barcode with the barcode reader 220, and in a fourth step 840, captures the delivery driver's signature 775 on the PDA screen 210 with the stylus 230. In a fifth step 850, the delivery driver presses the “Done” button 518 on the PDA screen 210. In a sixth step 860, at the delivery driver's press of the “Done” button 518, the signature 775 and unique barcode 600 containing the tracking information or the barcode 172 or the identifier barcode 174 are instantly transmitted via the wireless interface 260 or the computer 250, via the internet 270, and into the mail tracking database 300, where the information is stored for future reference.

Upon distribution of the trackable mailpiece 670 by the delivery driver to the recipient, in a seventh step 870, the delivery driver selects “Deliver Parcels” 512 in the operator menu of the mail tracking application on the PDA 200, in an eighth step 880, scans and captures the unique barcode 600 located on the printed receipt 610 or scans and captures the barcode 172 or scans and captures the identifier barcode 174 with the PDA barcode reader 220, and in a ninth step 890, captures the recipient's signature 770 on the PDA screen 210 with the stylus 230. In a tenth step 900, the recipient or the delivery driver can press the “Done” button 518 on the screen 210. In an eleventh step and at the press of the “Done” button 518, the signature 770 and the scanned and captured unique barcode 600 or the scanned and captured barcode 172 or the scanned and captured identifier barcode 174 containing the tracking information are instantly transmitted via the wireless interface 260 or the computer 250, via the internet 270, and into the mail tracking database 300, where the information is stored for future reference.

Information can be transmitted to the mail tracking database 300 for consolidation with similar information from other PDAs. The mail tracking database 300, which has been shown to be globally web-accessible, can be used for tracking, display of signatures, and data back up. At any time following initial data entry, information can be viewed, downloaded and printed, using a computer in any location, from the mail tracking database 300.

Although the description above contains many specifications, these should not be construed as limiting the scope of the present invention. They merely provide illustrations of some of the presently preferred embodiments of the present invention. It will further be understood that various changes in the details, materials and arrangements of the parts and parameters which have been described and illustrated to explain the nature of the invention may be made by those skilled in the art without departing from the principle and scope of the invention. Therefore, the spirit and scope of the appended claims should not be limited to the description of the preferred versions contained herein.

What is claimed is:

1. A real-time method for tracking mail comprising the steps of:
a. receiving a mailpiece delivered to a mail distribution facility;
b. accessing a globally accessible relational database via an internet connection;
c. collecting mailpiece identifying information with an intelligent, handheld, portable data entry and data processing device;
d. transmitting said identifying information via the internet connection to said globally accessible relational database;
e. collecting additional mailpiece information into a computer and transmitting said additional mailpiece information via the internet connection to said globally accessible relational database;
f. consolidating said mailpiece identifying information and said additional mailpiece information to genetate a unique barcode to enable continued tracking of the mailpiece;
g. scanning said unique barcode with an intelligent, handheld, portable data entry and data processing device;
h. transmitting information contained on the unique barcode via the internet connection to said globally accessible relational database
i. notifying a recipient of the mailpiece of arrival of the mailpiece;
j. scanning a pre-marked location identifying code that identifies a storage location of the mailpiece within the mail distribution facility;
k. transmitting said location identifying code via the internet connection to said globally accessible relational database;
l. distributing the mailpiece to the recipient of the mailpiece;
m. capturing a signature on the intelligent, handheld, portable data entry and data processing device;
n. transmitting the signature via the internet connection to said globally accessible relational database.

2. The method for tracking mail as recited in claim 1, wherein accessing a globally accessible relational database via an internet connection further comprises the steps of:
a. accessing a pre-installed web-based mail tracking software application on the intelligent, handheld, portable data entry and data processing device;
b. logging into the pre-installed web-based mail tracking software application by inputting an identification number;
c. inputting a password into the pre-installed web-based mail tracking software application;
d. pressing a “Login” button displayed by the pre-installed web-based mail tracking software application;
e. linking to the globally accessible relational database via an internet connection.
